(19) United States
(12) Patent Application Publication
(10) Pub. No.: US 2009/0164301 A1
(43) Pub. Date: Jun. 25, 2009

(54) Targeted Ad System Using Metadata

(75) Inventors: Joesph O'Sullivan, Oakland, CA (US); Marc Davis, San Francisco, CA (US); Athellina Athsani, San Jose, CA (US)

Correspondence Address: STATTLER - SUH PC, 60 SOUTH MARKET STREET, SUITE 480, SAN JOSE, CA, 95113, US

(73) Assignee: Yahoo! Inc., Sunnyvale, CA (US)

(21) Appl. No.: 11/963,349

(22) Filed: Dec. 21, 2007

(51) Int. Cl. G06Q 30/00; G06F 7/10; G06F 17/30

(52) U.S. Cl. 705/10; 705/14; 707/3; 707/E17.008

(57) ABSTRACT

A method for targeting advertisements selects a first content item that has an associated set of metadata. The associated metadata is for providing information regarding the first content item. The method identifies a first user having a relationship to the first content item. The first user has a set of profile information. The method determines a first metadata element such as, for example, a tag or keyword used by the first user in relation to the first content item. The first metadata element is generated by one or more users of the first content item such as, for example, the first user or a second user. The method selects a first advertisement for presentation to the first user. The selection process uses data associated with one or more of the first content item, the first user, and the first metadata element. Additional embodiments of the invention include a system and a computer readable medium for implementation of the foregoing.

### FIELD

The present invention is related to the field of advertising, and is more specifically directed to targeted ad system using metadata.

### BACKGROUND

The Internet provides a mechanism for merchants to offer a vast amount of products and services to consumers. Internet portals provide users an entrance and guide into the vast resources of the Internet. Typically, an Internet portal provides a range of search, email, news, shopping, chat, maps, finance, entertainment, and other Internet services and content. Yahoo, the assignee of the present invention, is an example of such an Internet portal.

When a user visits certain locations on the Internet (e.g., web sites), including an Internet portal, a system can capture the user's online activity. This information may be recorded and analyzed to determine patterns and interests of the user. In turn, these patterns and interests may be used to target the user to provide a more meaningful and rich experience. For example, if interests in certain products and services of the user are determined, content and advertisements, pertaining to those products and services, may be served to the user. Advertisements are usually provided by advertisers or marketers, who research and develop campaigns for the market. Content is typically provided by a network of publishers, often in conjunction with a portal provider. Recently much content on the Internet is generated, posted, and/or edited by users, for presentation to an audience of users. Such content may be referred to as user generated content (UGC). Moreover, various users who produce or consume content may further modify the content such as by tagging, commenting, augmenting with notes, descriptions, and the like. These user activities typically result in the generation of additional and/or associated information or data in relation to the base content.

Currently, advertising through computer networks such as the Internet is widely used along with advertising through other mediums, such as television, radio, or print. In particular, online advertising through the Internet provides a mechanism for merchants to offer advertisements for a vast amount of products and services to online users. In terms of marketing strategy, different online advertisements have different objectives depending on the user toward whom an advertisement is targeted.

Often, an advertiser will carry out an advertising campaign where a series of one or more advertisements are continually distributed over the Internet over a predetermined period of time. Advertisements in an advertising campaign are typically branding advertisements but may also include direct response or purchasing advertisements. A system that serves well targeted advertisements benefits both the advertiser/marketer, who provides a message to a target audience, and a user who receives advertisements in areas of interest to the user. Similarly, publishers and portals are benefited by increased relevance and/or traffic.

### SUMMARY

A method for targeting advertisements selects a first content item that has an associated set of metadata. The associated metadata is for providing information regarding the first content item. The method identifies a first user having a relationship to the first content item. The first user has a set of profile information. The method determines a first metadata element such as, for example, a tag or a keyword, used by the first user in relation to the first content item. The first metadata element is generated by one or more users of the first content item such as, for example, the first user or a second user. The method selects a first advertisement for presentation to the first user. The selection process uses data associated with one or more of the first content item, the first user, and the first metadata element.

The first user is generally either a producer or a consumer of the first content item. Preferably, the method associates the first metadata element to at least one of the first content item, the first user, and a second metadata element. The method also preferably collects a list of metadata elements and the associations of each metadata element. The list comprises a vocabulary of metadata elements for a particular set of users, or for a particular set of content items. Some embodiments crawl a set of content resources such as web pages, for example, to collect the list of user generated metadata elements. Selected advertisements are presented in conjunction with one of the first content item and the first metadata element. The profile information comprises one or more of demographic data, geographic data, behavioral data, interests, affiliations, groups data, and preferences, for the first user. The first content item comprises one of an image, a video, an audio clip, text, a link, a web page, a blog, and an online posting. The first metadata element of some embodiments is a user generated metadata element such as, for example, a tag, a tag cloud, a label, a comment, a rating, metadata, a content categorization, a genre categorization, and/or a description, that is entered by a content producer or a content consumer. The method of some embodiments further identifies a second user having a relationship to the first metadata element. Hence, a group of users are identified in relation to a metadata element or set of metadata elements. Alternatively, a set of metadata elements or vocabulary is determined for a specific user or group of users. Additional embodiments of the invention include a system and a computer readable medium for implementation of the foregoing.

### BRIEF DESCRIPTION OF THE DRAWINGS

The novel features of the invention are set forth in the appended claims. However, for purpose of explanation, several embodiments of the invention are set forth in the following figures.

FIG. 1 illustrates an example of user generated metadata elements in relation to a content item.

FIG. 2 illustrates user generation of metadata elements in further detail.

FIG. 3 illustrates a system for targeting and/or collection of user generated metadata elements.

FIG. 4 illustrates a system for selection of advertising based on user generated metadata elements.

FIG. 5 illustrates details of a system implementation in accordance with some embodiments.

FIG. 6 illustrates a process for collection and/or targeting of advertising based on user generated metadata elements.

FIG. 7 illustrates a system for presenting advertising of some embodiments.

FIG. 8 illustrates a system for placing and presenting advertising according to some embodiments.

FIG. 9 illustrates targeting in accordance with some embodiments of the invention.

FIG. 10 illustrates a landscape view of a scene from the real world.

FIG. 11 illustrates a mobile device for capturing part of the view of FIG. 10.

FIG. 12 illustrates a mobile device display that includes metadata for an object within the view of FIG. 10.

FIG. 13 illustrates notes type metadata in conjunction with content.

FIG. 14 illustrates tagging of media along a timeline.

FIG. 15 illustrates several examples of metadata used by some embodiments of the invention.

FIG. 16 illustrates a device according to some embodiments.

FIG. 17 illustrates a model for the relationships between metadata, users, and content items.

### DETAILED DESCRIPTION

In the following description, numerous details are set forth for purpose of explanation. However, one of ordinary skill in the art will realize that the invention may be practiced without the use of these specific details. In other instances, well-known structures and devices are shown in block diagram form in order not to obscure the description of the invention with unnecessary detail.

Embodiments of the invention improve ad focus and ad targeting by leveraging metadata elements that are associated to content items to determine ad relevancy. The metadata elements are obtained from one or more of the following information sources: users, content resources, and/or content items.

A content resource or item is an entity to which the metadata element is associated. Content items include user generated content such as multimedia in the form of images, video, audio, text, web pages, links, blogs, posts, and other content.

In this document, users are the producers and/or consumers of content items and of user generated metadata elements associated thereto. A consumer of content, for instance, includes a viewer of video and image content, and a listener of audio content. Producing and consuming are not mutually exclusive activities. Hence, producers of content often consume the content of others, while consumers of content may also produce their own content and associate user generated metadata elements to their own content, or to the content of others. An influential user of a particular content item, does not generally generate the original content item, but usually modifies the content item by adding metadata elements such as, for example, titles, captions, description, notes, keywords, commenting, tagging and the like. An influential user may further repackage, reorganize, and/or redistribute the content to other users in collections or formats that are easier to find. One of ordinary skill recognizes that users interact, consume, and/or modify content by using a variety of devices, including networked, enabled, and/or portable or mobile devices.

Metadata elements, as used herein, refer to any additional content used to augment base or original content including user generated or submitted content. Hence, metadata elements include tags, tag clouds, labeling, comments, titles, captions, notes, keywords, ratings, content or genre categorization, descriptions, and other associated data and/or metadata that are entered by the content producers or content consumers such as, for example, viewers of the content.

The relevancy of various advertising is advantageously determined by constructing and using a vocabulary of metadata elements including vernacular information. The vocabulary is constructed by aggregating data from one or more of the information sources and/or combinations thereof. In particular implementations, the vocabulary is constructed based on the relationship between a combination of metadata sources. Accordingly, in one embodiment, the metadata sources include (1) a content item, (2) users of the content item, and (3) user generated metadata elements associated with the content item. In other embodiments, the metadata sources include (1) a content item and (2) user generated metadata elements associated with the content item. In a further embodiment, the metadata sources include (1) users of a content item and (2) user generated metadata elements associated with the content item, and/or associated with the users of the content.

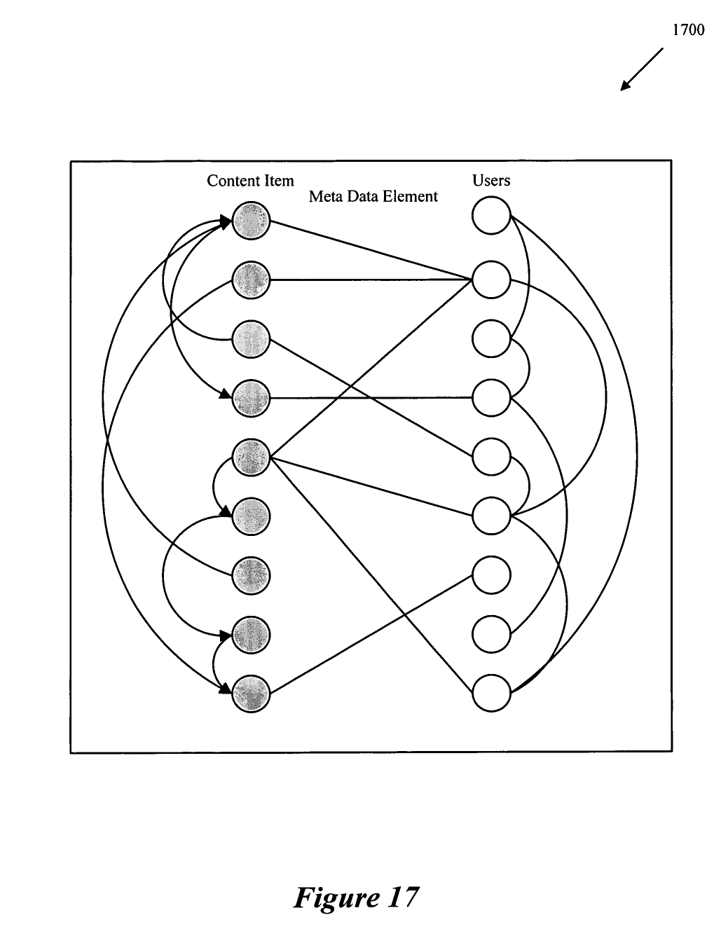

Alternatively, the vocabulary is constructed based on the relationship between each information source in relation to other sources of the same type such as, for example, the relationship between content item A, content item B, and content item C, between a first metadata element and a second metadata element, and/or between two or more users. The foregoing relationships are further described in relation to FIG. 17. By building a language around content, users, and/or user generated metadata elements, embodiments of the invention advantageously serve advertising at a more personal and/or better targeted level.

The advertising system of some embodiments includes two aspects. One implementation selects an advertiser for a metadata element or set of metadata elements. In this implementation, users who conduct searches that are relevant to the metadata element(s) are presented with the selected advertiser's advertisements. A second implementation involves ad perpetuation through a network of content producers such as, for example, Yahoo's Publishing Network. In these implementations, the system relies on web crawlers to crawl or traverse a content producer's content resources (e.g., web page contents) to determine and serve relevant content including advertisements.

Content Items and Content Resources

Currently over the Internet, users exchange and interact with a variety of content items. Example content items include photos, images, blogs, web pages, audio, video and other media and content. With the proliferation of user generated content (UGC), many web sites, entities, and/or online content items feature the ability to augment content with user generated metadata elements such as, for example, keyword and/or tagging capabilities. Users augment content items such as, for example, web pages, blog posts, images, universal resource locators (URL's), video, audio, and other content with user generated metadata elements.

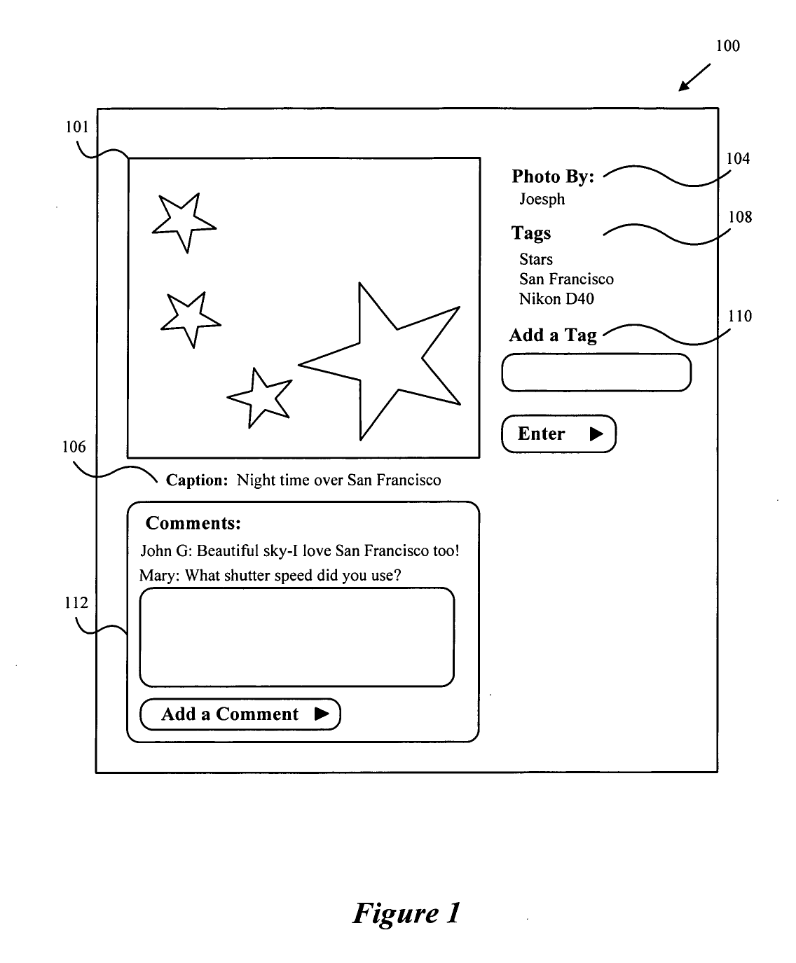

For instance, FIG. 1 illustrates a web page 100 comprising a content item 101 of a user 104 that has associated metadata elements. The metadata elements are user generated, or alternatively are generated by a system for providing additional information along with the content item 101. Some content items include both user generated and system generated metadata. As shown in this figure, the exemplary content item 101 or resource is a photograph of stars in the night sky over San Francisco that was taken and/or uploaded by the user Joseph 104. The user 104 has uploaded the content item 101 to a web page for sharing with other users having similar interests.

The web page 100 has several placements for receiving, storing, and/or presenting metadata elements of a variety different types. For instance, the web page 100 includes a caption 106, comments 112, and tags 108 and 110. One of ordinary skill recognizes additional forms of metadata elements, placements, and/or associations for metadata elements in relation to various types of content items. In this example, the caption 106 may include a title and includes several user generated keyword type metadata elements. The tags include producer tags 108 that are entered by the producer of the content item 101, and other tags 110 that are entered by other users, such as by viewers and/or consumers of the producer's content. Hence, the web page 100 includes a placement for existing tags, as well as a field for user entry of additional tags, and thereby the generation and/or association of additional user generated metadata elements. The existing tags are optionally associated by the producer of the content, the uploading user 104, or by another user.

Similarly, the web page 100 includes a placement for the presentation of existing comments, as well as a field for the user entry of additional comments. As with the other information that is received, stored, and/or presented in conjunction with the content item 101, the comments also contain a number of user generated metadata elements such as keywords, for example. In the example of FIG. 1, the web page 100 is from a content and/or photo sharing site, the content item 101 is an uploaded image, and the metadata elements are in the form of a caption 106, tags 108 and 110, and comments 112 that are associated with the image content item 101. One of ordinary skill, however, recognizes other web sites, other types of content items, and other sources for metadata elements.

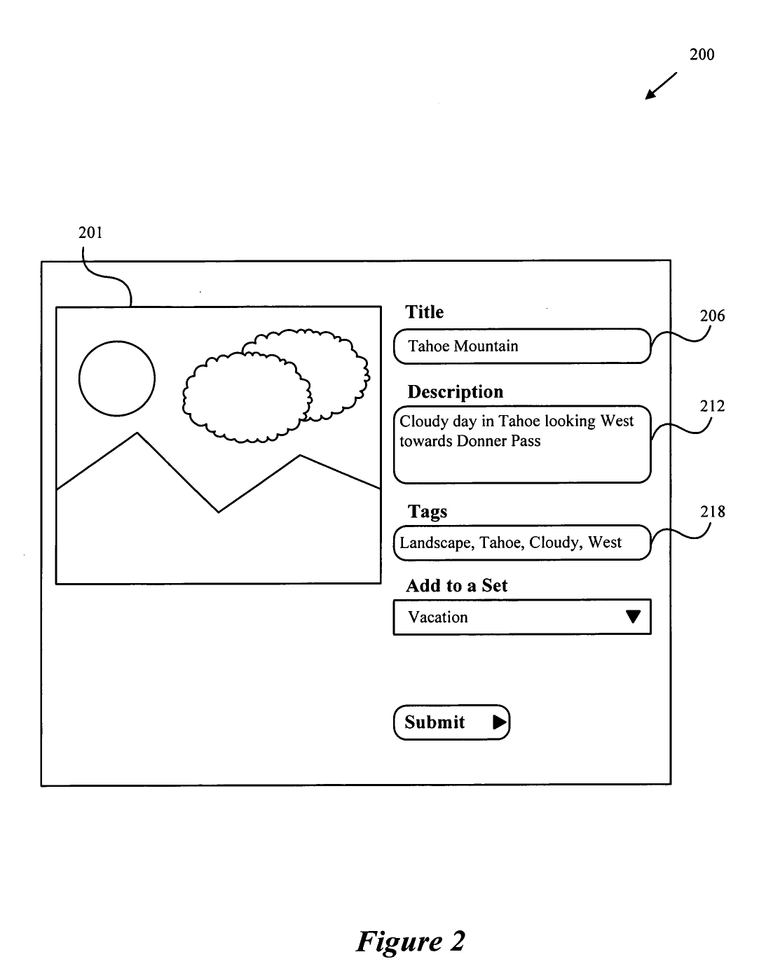

FIG. 2 illustrates the generation and/or association of metadata elements including user generated metadata elements according to some embodiments. For instance, in one embodiment, FIG. 1 depicts a web page 100 from a website for online image sharing, while FIG. 2 illustrates another web page 200 for uploading of a content item and associating additional information with the content item. As shown in FIG. 2, the web page 200 includes a content item 201, and several user configurable fields for setting preferences, or for associating additional information with the content item 201. In this case, the content item 201 is an image of a Tahoe mountain landscape. The fields include a field for adding a title or caption 206, for a description 212, and for adding tags 208 and 210. The web page 200 further includes a field to add the uploaded image to a set 214, which is a form of categorization. Each of these fields operates as a source for the generation and/or association of metadata elements. As shown in the figure, the metadata elements include information that the content item 201 has relevance to mountains, clouds, Donner Pass, vacation, and other information for the content, one or more users, and/or for the website, system, and/or location.

Embodiments of the invention advantageously collect information from the metadata elements, from the content item, and/or from the user(s). Some embodiments collect and/or store the information from the different sources as metadata. Some implementations employ a web crawler to crawl the various web pages of content items and information sources associated with the content items to identify and/or collect various metadata elements. The metadata element are preferably organized in a vocabulary. The metadata elements are further used to match the content item and/or user to a specific advertiser, and/or a particular advertisement.

Users include a variety of types that are not mutually exclusive. As described above, users often generate metadata elements while generating and/or producing content, uploading content, and/or modifying existing content such as by tagging, commenting, and/or associating other additional data to base content. The system of some embodiments further utilizes various user data for the targeting of advertisements. Some of the user data used includes user profiles, preferences, and/or interests, users' affiliation with social networks or communities, and/or contextual, demographic, and/or geographic user data such as user location, local time, season, weather, cultural, and/or contextual user information. Each of the foregoing information is either implicit or explicit. For instance, a user profile may state an explicit affiliation with the social network digg.com, but may be implicitly associated with the skateboarding community for the use of the term “gnar” within a specific context. Some embodiments advantageously identify explicit and implicit affiliations of users by using the vocabulary of metadata elements.

Since users constantly add, delete, and/or edit metadata elements, the metadata gathered by users is constantly changing and/or updating. Hence, some embodiments operate as a trend-keeper for user types, user behavior, and vernacular language. These embodiments further compile implicit user profiles, preferences, and interests, and identify implicit social networks or communities, based on aggregated user behavior in relation to metadata elements including user generated metadata elements. As mentioned above, metadata elements arise in a variety of content and/or metadata such as, for example, in tags, tag clouds, comments, labeling, categorization, descriptions, and/or metadata entered by the content producers or content viewers. Using metadata elements including user generated metadata elements in conjunction with other user and/or content type data to serve ads allows some embodiments to place targeted ads by using by using special language syntaxes such as metaphors, vernacular or cultural language, slang, contextual language, and the like. The system of some embodiments makes recommendations to advertisers based on vocabulary relevancy of metadata elements to the advertisements.

System

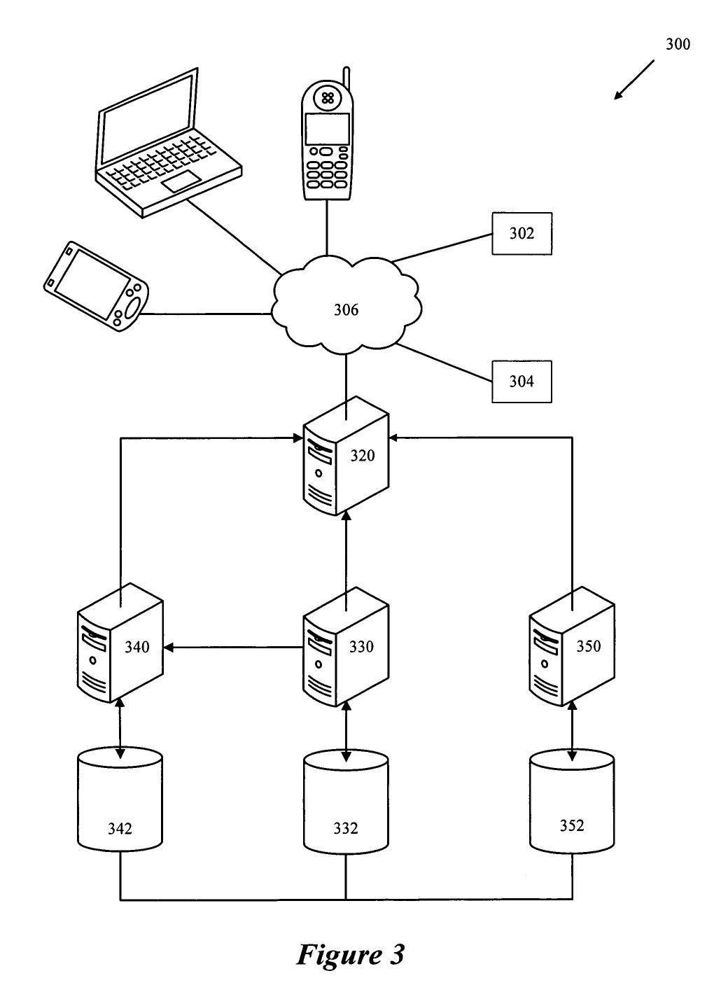

The system of particular embodiments leverages the co-occurrence of specific items, users, and/or user generated metadata elements to determine a vernacular vocabulary for the user generated metadata elements and use the vocabulary to serve more targeted advertisements. FIG. 3 illustrates an advertising system 300 that uses metadata elements including user generated metadata to achieve the foregoing in accordance with some embodiments. As shown in this figure, the system 300 includes a targeting engine 320 that is coupled to a profile server 330, a content server 340, and a metadata server 350. Each server includes a data storage such as, for example, a profile storage 332 for the profile server 330, a content storage 342 for the content server 340, and a metadata storage 352 for the metadata elements server 350. The servers 330, 340, and 350 collect, organize, and/or or store each type of data. For instance, the profile server 330 stores and/or retrieves user type data by using the profile storage 332, the content server 340 stores and/or retrieves information about various content items by using the content server 342, and the metadata server 350 manages information for a variety of metadata elements by using the metadata storage 352. Advantageously, the targeting engine 320 employs the various information to direct content and/or advertising to specific users 302 and 304. The users 302 and 304 may use different devices to interact with the network 306.

In contrast to the embodiments described herein, conventional “text match” systems employ simple text match to determine and serve advertising to users. However, conventional advertising based only on text matches typically relies upon only one source of information to determine ad generation. These traditional text match based systems undesirably use only a single source of information such as, for example, user input, or site content web crawling. The user input is usually in the form of text entry on a search box, or user clicking on a link to specific subject matter. Such a one dimensional data source may not serve relevant ads for the search users or site surfers which in turn does not help advertisers reach the right audience.

For instance, the term “Puma” may arise in conjunction with user tagging of content including user generated content. However, some of the users of the term “Puma” may refer to a cat, while another group of users may refer to a shoe brand. Without further information, an advertising system based only on the text match will likely incorrectly target advertisements for the cat and the shoe to the wrong groups of users.

Accordingly, some embodiments of the invention understand that user generated metadata elements that include the terms “Puma, Cool, and Trendy” are used by one User Community A to describe shoes. These embodiments further understand that another User Community B uses the terms “Puma, Savannah, and Cat” to describe a type of cat. In one implementation, the system preferably targets shoe advertising to the first Community A, and targets different advertisements toward the second Community B. For example, the advertisements for the second Community B may include ads for National Geographic and for visiting the local zoo. Compared to conventional text based advertising systems that only rely on one source (often of only static metadata), some embodiments advantageously obtain metadata from one, two, or three sources such as, for example, the content item, the user(s), and/or the user generated metadata element(s) described above.

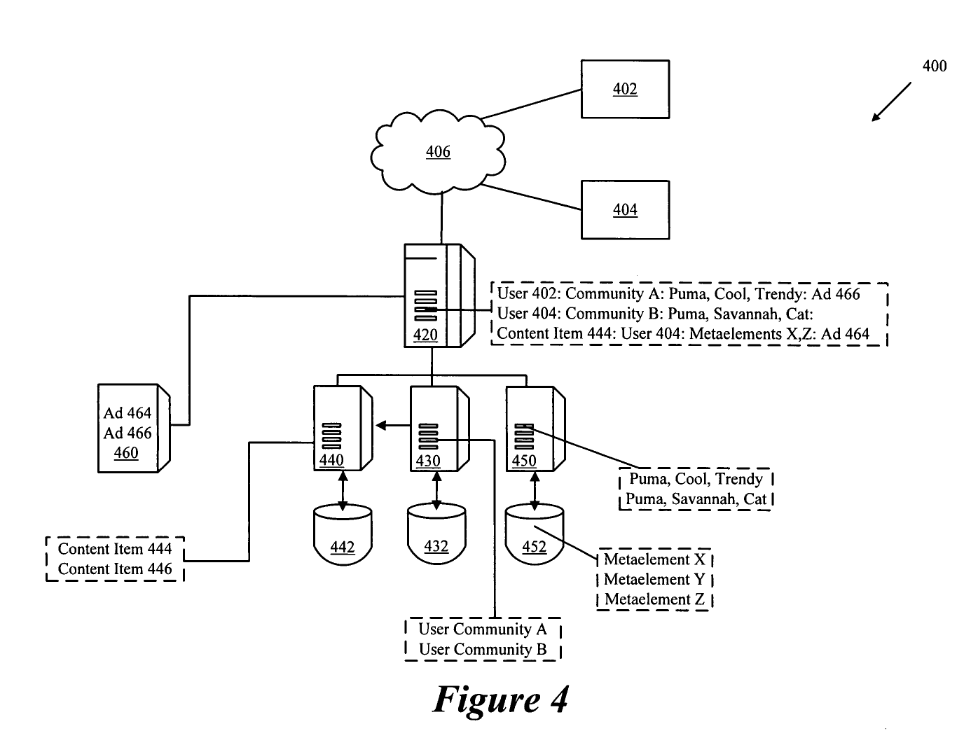

FIG. 4 illustrates such an embodiment 400 in further detail. As shown in this figure, a targeting engine 420 uses information managed and/or stored by the various servers 430, 440, and 450, and data storages 432, 442, and 452. For instance, a set of metadata elements include the terms “Puma, Cool, Trendy” that are associated with the User Community A by the targeting engine 420. Similarly, the targeting engine associates the terms “Puma, Savannah, Cat” with the User Community B. Moreover, some embodiments further associate the metadata elements of each user community with specific content items for the user and/or community of users. Once the associations are determined, particular embodiments advantageously select an advertisement for presentation based on one or more of the user data, the content item data, and/or the metadata element(s). As shown in FIG. 4, the advertisement is preferably selected from an advertising storage 460 that stores and/or manages information from a variety of advertisements and/or advertising campaigns such as the exemplary ads 464 and 466. Moreover, the selection and/or presentation of advertisements may further include information relating to specific content such as the exemplary content items 444 and 446, in relation to any number of determined and/or stored metadata elements X, Y, and Z.

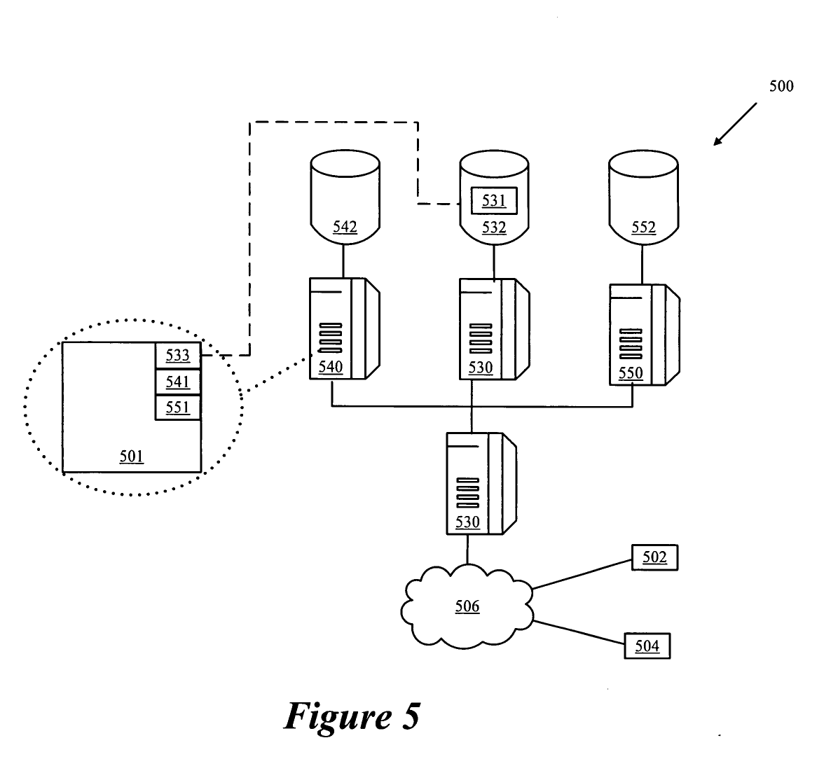

FIG. 5 illustrates an additional system implementation 500 for targeting advertisements by using content information, user information, and/or metadata elements. As shown in this figure, the content information 541 usually comprises contextual data about the content item 501 that is often stored (e.g., by using the module 540 and/or the storage 542) as metadata associated with the content item 501. The metadata elements 551 of some embodiments also comprise additional information about the content item that is stored as associated metadata. User information 531 associated with the content item, however, is preferably stored in a user profile database 532 that is separate from the content item. In these cases, an identifier 533 that identifies the user profile information in the user database 532 is included with the metadata associated with the content item. Similarly, a list of metadata elements or vocabulary collected from several content items and preferably relevant associations for each metadata element, is stored separately from the content such as by using a separate module 550 and/or storage 552.

One implementation scours a publisher's network of sites for relevant advertising placements from the publisher's existing content. The placements are identified from the network's community, from the content item, or based on the metadata element(s). In one embodiment, users benefit from the monetization of user generated metadata elements by sharing advertising revenue from the web operator. This also encourages users to include better user generated metadata elements with content. Some embodiments include a feedback and/or rating feature that allows users to vote on the user generated metadata elements or directly on the relevancy or interestingness of advertising. The feedback is in the form of ratings, comments, and the like. The feedback is preferably tabulated to determine, adjust, or add to the system's vernacular vocabulary and to make recommendations regarding metadata elements to the advertisers for targeting purposes.

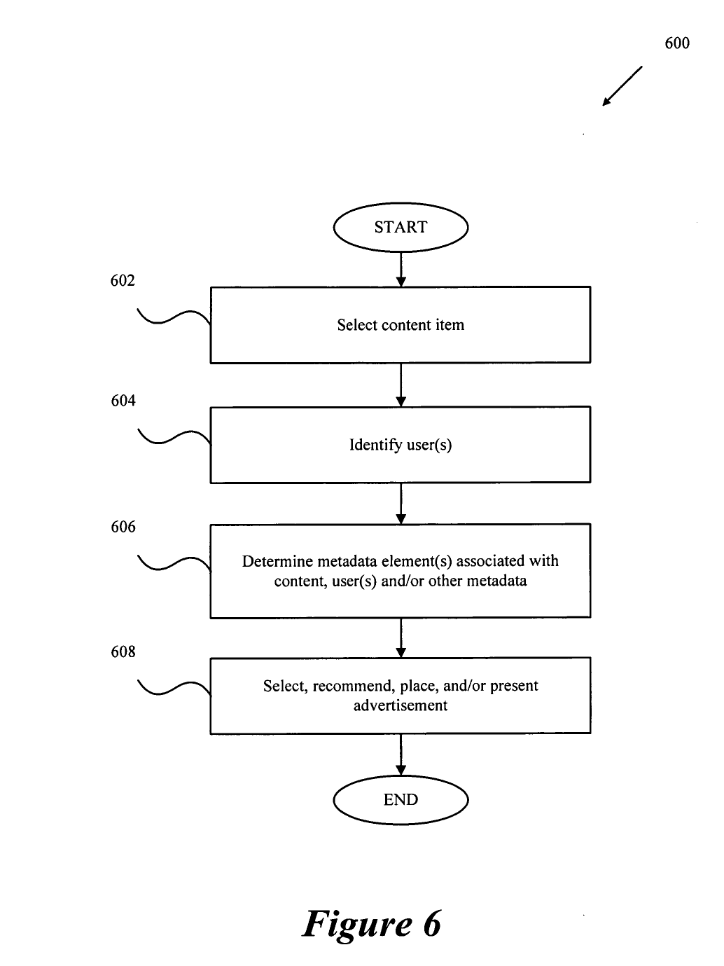

FIG. 6 illustrates a process 600 that summarizes some of the operations performed by the foregoing embodiments. As shown in this figure, the process 600 begins at the step 604, where a first content item is selected. The selected content item has an associated set of metadata for providing information regarding the first content item. Once the first content item is selected, the process 600 transitions to the step 608.

At the step 608, the process 600 identifies a first user having a relationship to the first content item. The first user usually has a profile and other information that describes the first user. Then, at the step 612, the process 600 determines a first metadata element used by the first user in relation to the first content item. For instance, as illustrated in FIGS. 1 and 2, the first metadata element is provided by a producer during content generation and/or uploading. This type of metadata element might include a title, a description, a tag, or another source of information for the metadata element. Alternatively, the metadata element is provided by a consumer of the content such as, for example, by a comment posted by a viewer of image or video content. Preferably, the determination at the step 612 further includes constructing relationships and/or associations between the first metadata element, one or more content items, one or more users or groups of users, and/or one or more additional metadata elements. For example, a first metadata element “gnar” may be associated with one or more of a skateboarding content item, a group of skateboarding users, and/or a second metadata element “skater.”

Further, at the step 612, the process 600 preferably compiles and stores a list of determined metadata elements and related associations into a vocabulary. The list or vocabulary is preferably updated to include new metadata elements and the associations of the new and previously determined metadata elements that are already present within the vocabulary. At the step 616, the process 600 selects a first advertisement for recommendation, placement, and/or presentation to a user, such as the first user or a second user. The selected advertisement is optionally presented in conjunction with the first content item, with the first metadata element, or both. After the step 616, the process 600 concludes.

Targeting, Placement, and Presentation Systems

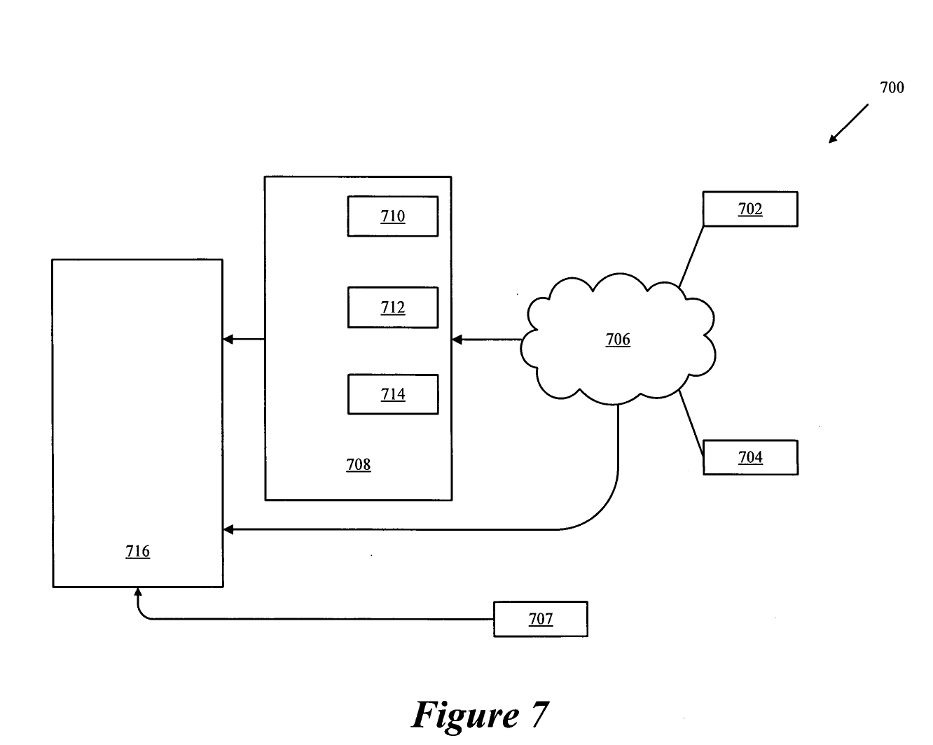

FIG. 7 illustrates a system 700 that presents advertising to users through a network. As shown in this figure, the system 700 includes a plurality of users 702 and 704 that interact with a network 706. As mentioned above, the user 702 and 704 may interact with the network 706 by using a variety of different types of devices. The network includes local area networks, wide area networks, and networks of networks such as the Internet, for example. The network 706 typically includes several sites comprising a number of web pages having content and advertising inventory. The ad inventory is for the presentation of advertising to the users 702 and 704. Accordingly, the network 706 is coupled to an exemplary site or page 708 that includes several inventory placements, surfaces, insertion points, and the like 710, 712 and 714. The site 708 may further include user generated content and is coupled to a server 716 for data collection and processing. The server 716 receives data from a variety of sources, including directly from the users 702 and 704, from the network 706, from the site 708, and/or from another source 707. Typically, the site 708 is provided by a publisher, while the server 716 is typically provided by a portal operator, and/or an ad network. Further, as users 702 and 704 interact with the network 706, and the site 708, metadata elements are generated and collected by the server 716, and advertisements placed in the inventory of the site 708, are presented to the users 702 and 704.

The selection and/or presentation of advertising through the inventory are non trivial processes. The inventory is typically distributed across many varied sites, zones, domains and pages. There are many different types of content, users, and types of users. Moreover, marketers, advertisements, and ad campaigns are usually numerous and varied as well. Timely, relevant, appropriate and/or coherent matching and delivery of content such as advertising is a problem that can have millions of input data points, or more.

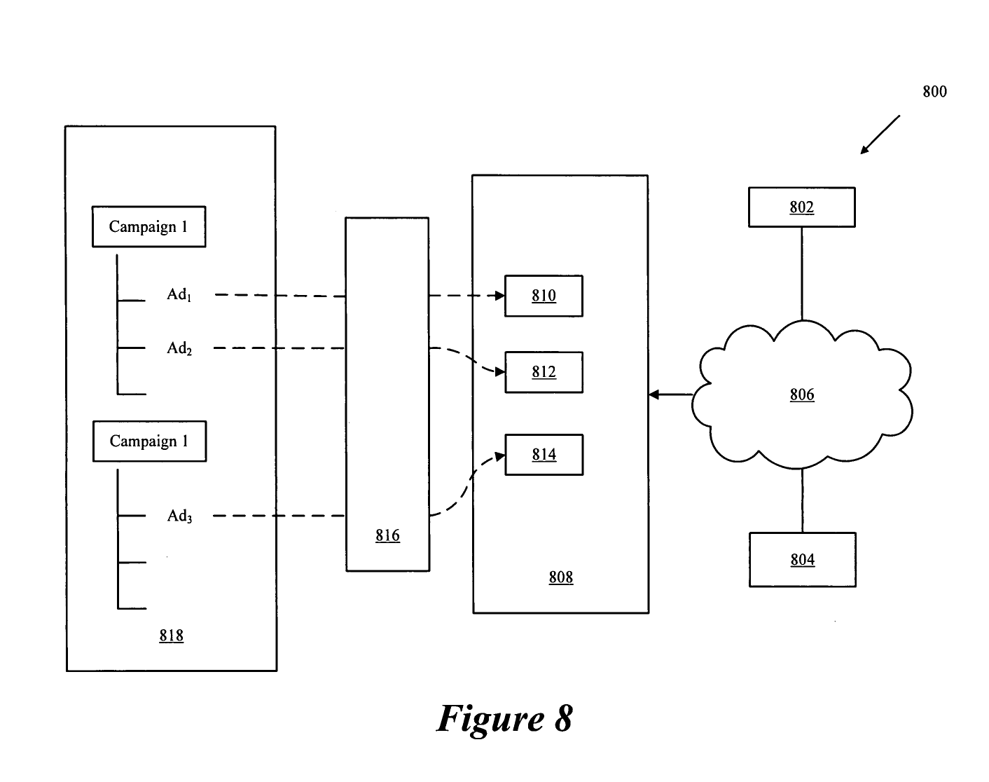

Hence, FIG. 8 illustrates a system 800 for the intelligent selection of advertising for the site 808, and the presentation of the selected advertisements to the users 802 and 804 through a network 806. As shown in this figure, the system 800, includes a server 816 coupled to the site 808, and a user 818 who provides information to the server 816. The users are varied and include, for example, producers, viewers, publishers, advertisers and/or marketers. Advertisers and/or marketers, for instance, generally have one or more ad campaigns that have one or more advertisements that are provided to the system 800. A campaign and advertisements within the campaign are designed to promote an activity toward conversion by the user such as, for example, to generate a user impression, to generate a click, a lead, and/or an acquisition. Accordingly, advertisements from the various campaigns of the marketer 818, are selected and/or placed with the inventory 810, 812, and 814, of the site 808. Preferably, the selection is based on a variety of data that is collected and/or received by the server 816. The data includes user data, publisher data, content data, metadata, and/or marketer data that is compiled, processed, and stored in certain advantageous ways such as by using the advertising network and/or systems that use metadata, as described above.

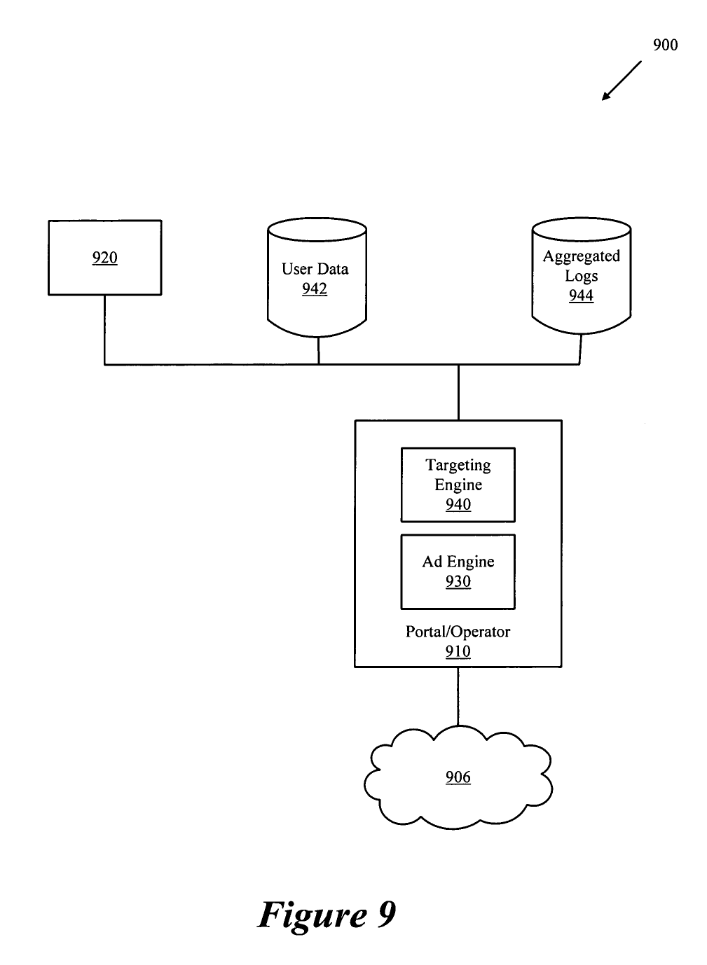

The data collection and processing of some embodiments further includes targeting such as behavioral and/or user data targeting. Accordingly, FIG. 9 illustrates a system 900 for processing and management of such information. As shown in the figure, the system 900 includes a targeting engine 940 that is coupled to a storage device 942 for user information, and a storage device 944 for log information such as aggregated activity logs, for example. The targeting engine 940 is further coupled to additional modules, servers, and/or storages 920, for the collection of metadata, including user generated metadata. Preferably, as users including viewers, producers, and advertisers interact with the system 900 (e.g., interact with content and advertising and/or generate metadata), the system 900 collects information regarding their activities by using the engine 940, the storage devices 942 and 944, and other components 920 of the system 900. Advantageously, the collected data is retrieved and processed for a variety of characteristics such as behavioral, affinity, and/or preference data of particular users, groups, demographic, and/or geographic data. Some implementations further process content information and/or metadata in conjunction with the user, behavioral and other data. The system 900 of particular embodiments may further use these data for the selection, placement, and/or presentation of advertisements in conjunction with user generated metadata elements, as described above.

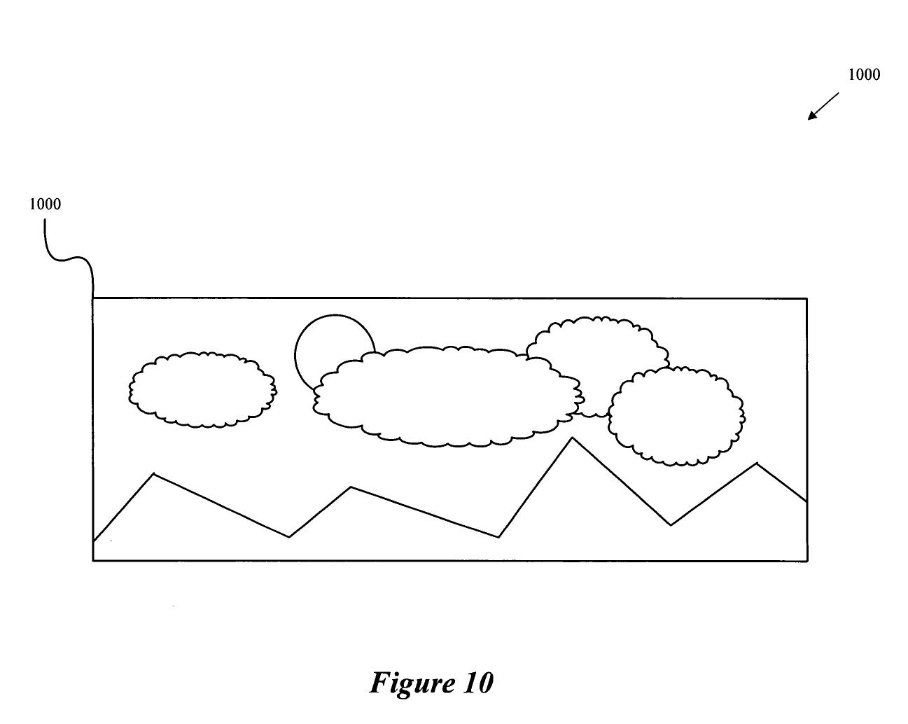

FIG. 10 illustrates a landscape view of a scene 1000 from the real world. As shown in this figure, the scene 1000 includes several objects such as, for example, clouds, sky, and mountains. One of ordinary skill recognizes that these objects are merely representative, and that a scene from the real world may have any number of different objects in the field of view. It is further understood that these various exemplary objects have a variety of features including metadata such as tags, keywords, and the like, that may be used for presentation of additional content, or content within or associated with content, such as advertising, for example. As described above, embodiments of the invention provide methods and systems for determining metadata, users, and content for presenting advertising.

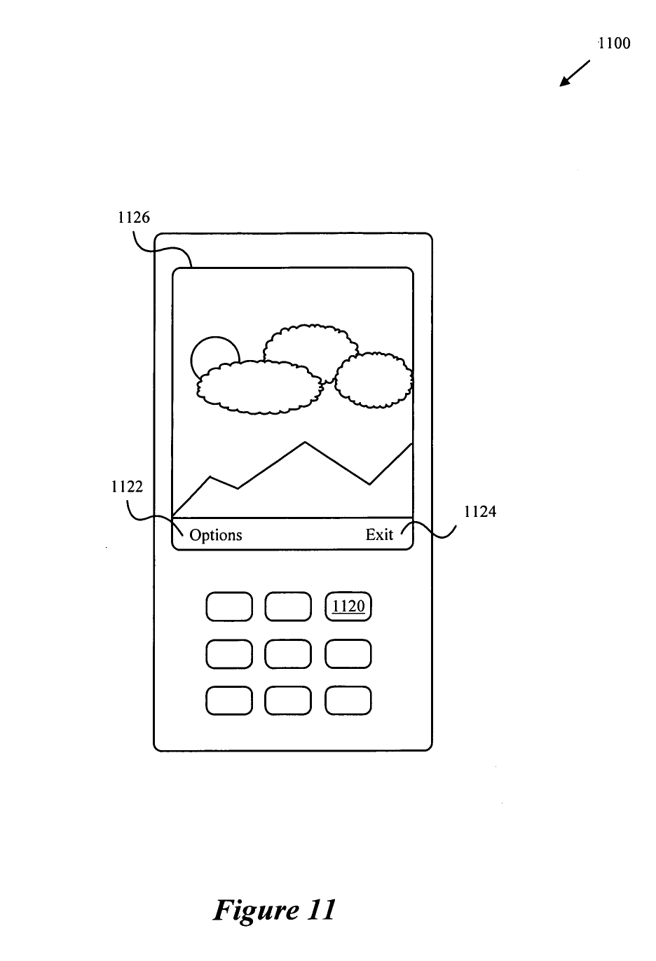

Accordingly, FIG. 11 illustrates a mobile device 1100 for capturing part of the view of FIG. 10. As shown in FIG. 11, the mobile device 1100 includes user interface features such as buttons 1120, menu items 1122 and 1124, and a display 1126. The device 1100 may further include a mechanism for capturing content such as, for example, a camera that captures still images or video frames. In these embodiments, when pointed at objects and/or used to capture content, the display 1126 preferably captures and/or presents the objects and one or more metadata elements of the objects to a user of the device 1100. One of ordinary skill recognizes the metadata of different embodiments.

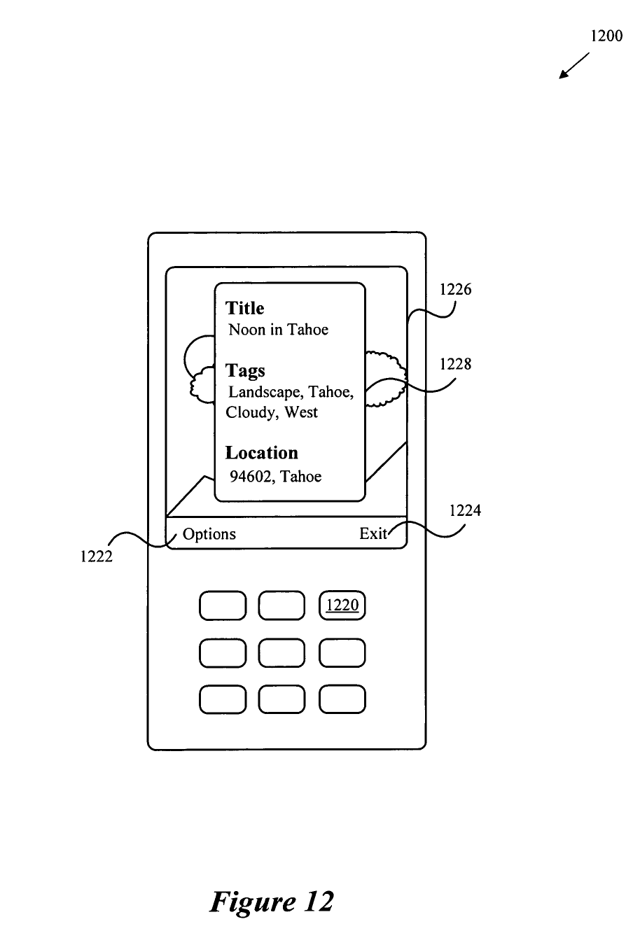

For instance, FIG. 12 illustrates a mobile device 1200 for capturing part of the view of FIG. 10, and/or for using metadata elements that are associated with the objects within the captured view. Hence, when the device 1200 is used to capture a portion of the scene 1000 of FIG. 10, a set of metadata elements may be attributed to the content and/or presented to the user through the display 1226. As shown in FIG. 12, the exemplary metadata elements include title, tags, and location type metadata elements. In this manner, some embodiments include a device 1200 that attributes and/or presents the metadata elements of various content.

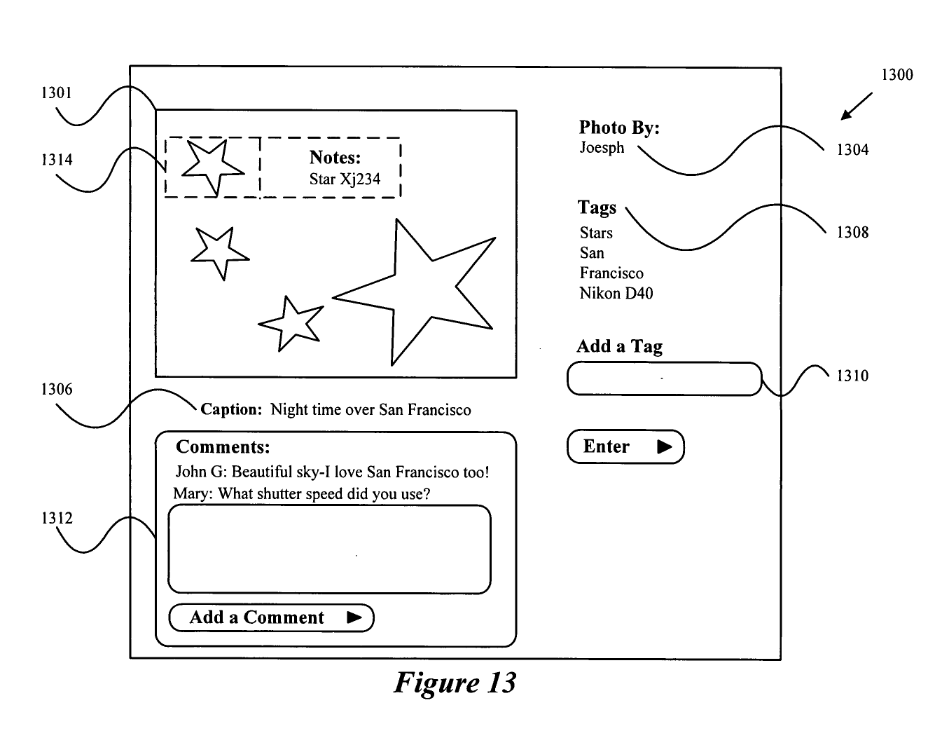

FIG. 13 illustrates notes type metadata in conjunction with content. As shown in this figure, a web page 1300 comprising a content item 1301 of a user 1304 has various associated metadata elements. In this example, the content item 1301 or resource is a photograph of stars in the night sky over San Francisco. The user 1304 has uploaded the content item 1301 to a web page 1300 for sharing with other users having similar interests.

The web page 1300 has several placements for receiving, storing, and/or presenting metadata elements of a variety different types. For instance, the web page 1300 includes a caption 1306, comments 1312, and tags 1308 and 1310. In this example, the tags include information regarding the capture device as a Nikon D40 digital camera. One of ordinary skill recognizes additional forms of metadata elements, placements, and/or associations for metadata elements in relation to various types of content items. These metadata elements may include object type metadata elements and/or associations.

In this example, the caption 1306 may include a title that comprises user generated terms and/or keywords. The tags include producer tags 108 that are entered by the producer of the content item 1301, and other tags 1310 that are entered by other users, such as by viewers and/or consumers of the producer's content. Hence, the web page 1300 includes a placement for existing tags, as well as a field for user entry of additional tags, and thereby the generation and/or association of additional user generated metadata elements. The existing tags are optionally associated by the producer of the content, the uploading user 1304, or by another user.

Similarly, the web page 1300 includes a placement for the presentation of existing comments, as well as a field for the user entry of additional comments. As with the other information that is received, stored, and/or presented in conjunction with the content item 1301, the comments also contain a number of user generated metadata elements. In the example of FIG. 13, the web page 1300 is from a site for sharing photographs, for example, the content item 1301 is an uploaded image, and the metadata elements are in the form of a caption 106, tags 108 and 110, and comments 112 that are associated with the image content item 101. One of ordinary skill, however, recognizes other web sites, other types of content items, and other sources for metadata elements.

For instance, FIG. 13 further illustrates notes type metadata 1314 is associated to one of the stars in the image content 1301. This type of metadata may be referred to as segment type metadata, which is associated with a specific portion of content or a specific portion of an object within the content. By contrast, object type metadata is associated with an entire object within the content or with the content in general. As shown in the figure, the note 1314 includes the information that the star is Star XJ234, however, one of ordinary skill recognizes additional notes and/or segment type metadata.

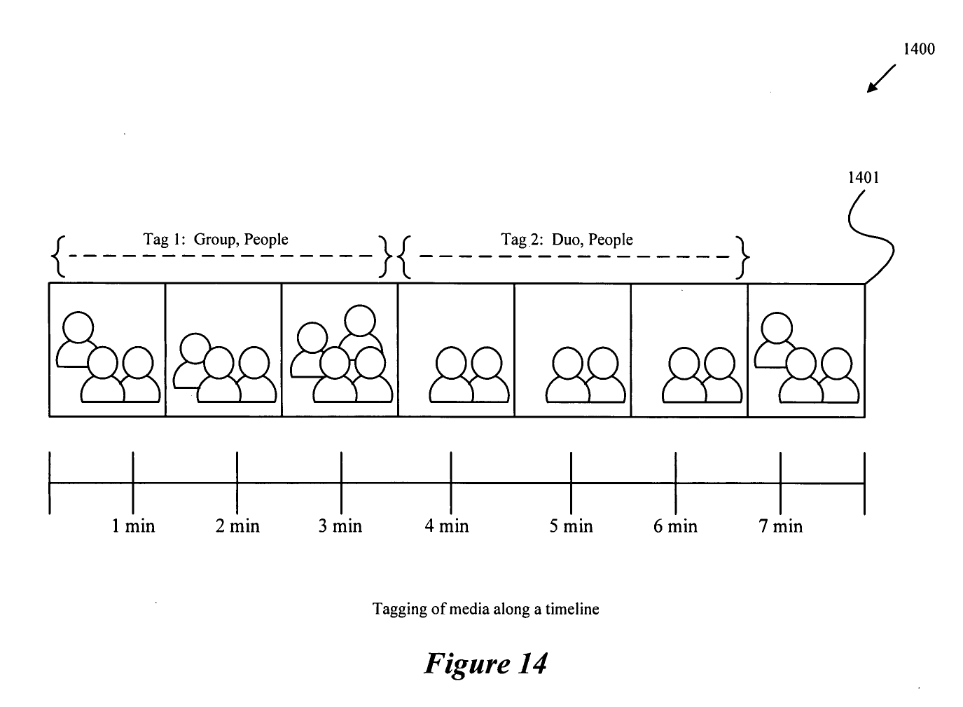

FIG. 14 illustrates metadata associated with another type of content 1401. More specifically, FIG. 14 illustrates tagging of video frame media along a timeline. As shown in this figure, the frames at minutes one, two, and three of the video sequence 1401 are tagged with Tag 1 that includes the terms and/or keywords “Group” and “People.” One of ordinary skill recognizes other terms that are appropriately associated as metadata elements to the content 1401, and/or other content items. The video frames at minutes four, five, and six are associated with a different tag, Tag 2 that comprises the terms “Duo” and “People.” According to FIG. 14, the “Duo” term and/or tag is more descriptive of the subject matter of the video frames at minutes four, five, and six of the video sequence 1401.

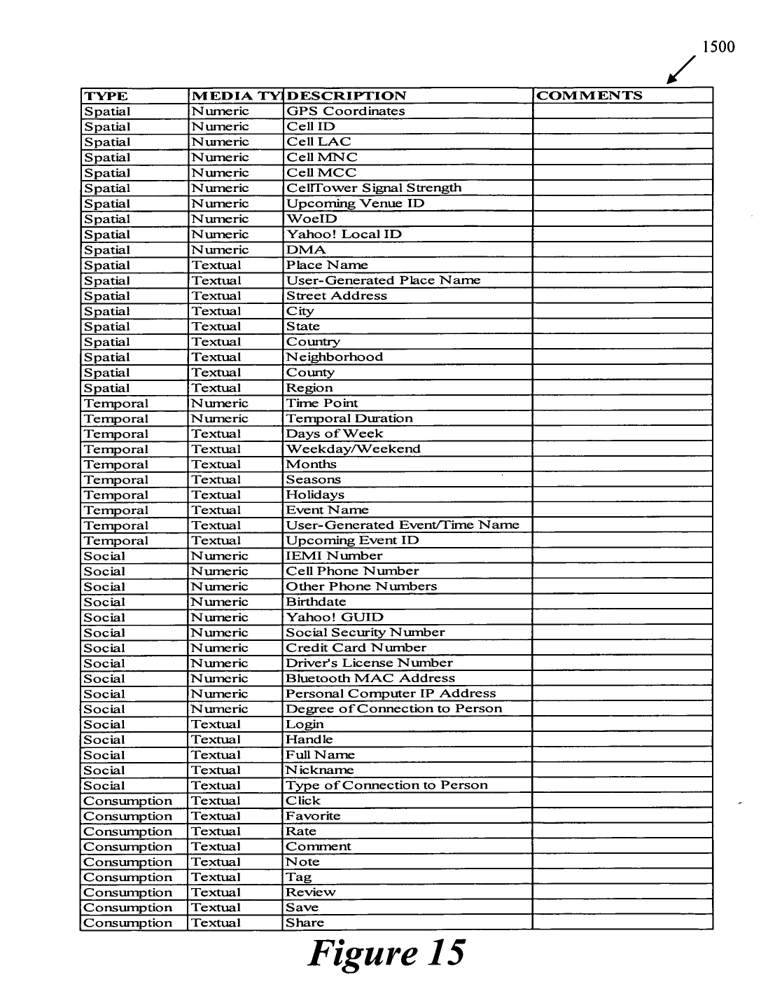

FIG. 15 lists a variety of examples of metadata types employed by embodiments of the invention. Different forms of spatial, temporal, and/or social metadata of the kinds listed in this figure are associated or attached to a variety of content items and/or objects in any phase of the content item's lifecycle such as, for example, production, consumption, sharing, and/or reuse. Moreover, some embodiments include standard content metadata such as, for example, file name, file size, and the like, in addition to the contextual (spatial/temporal), community (social), and consumption type metadata that are listed in the examples of FIG. 15.

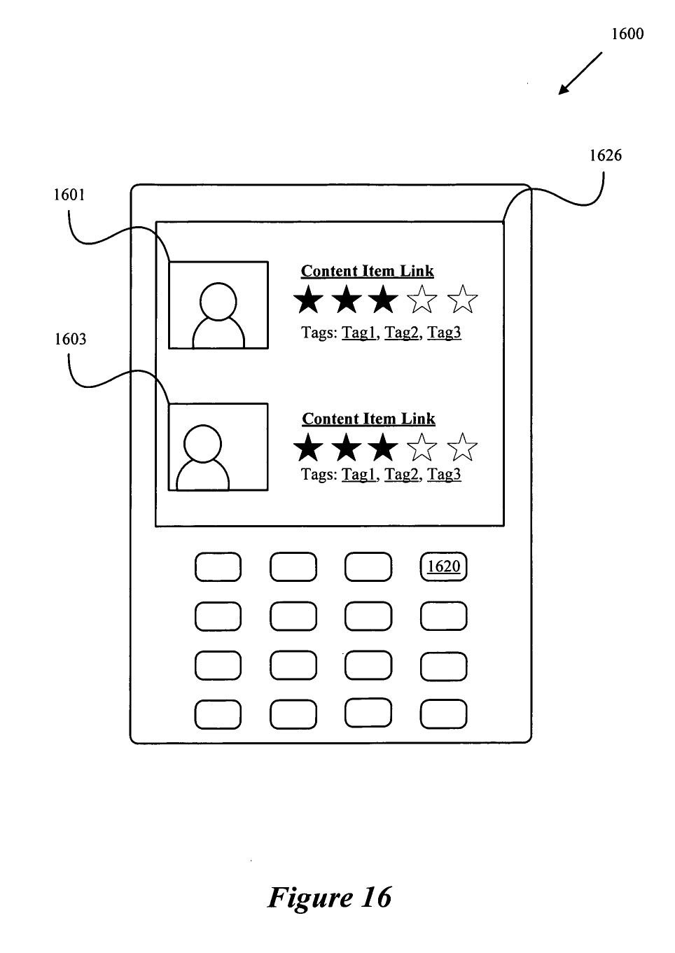

FIG. 16 illustrates a device 1600 according to some embodiments. As shown in this figure, the device 1600 includes one or more buttons 1620 for performing a variety of functions, and a display for 1626 for providing content. In the illustrated implementation, the display presents two content items 1601 and 1603 that are images of people. Each content item 1601 and 1603 has associated metadata such as, for example, tags exemplified by Tag 1, Tag 2, and Tag 3. The metadata elements further include a link that is related to each content item 1601 and 1603, and ratings of each content item 1601 and 1603. For instance, each content item 1601 and 1603 has an associated rating of three out of five stars.

FIG. 17 illustrates a model 1700 for the relationships between metadata, users, and content items. As shown in this figure, the content items may be represented by a column of nodes on the left side of the model 1700, while users are represented by a column of nodes on the right. The content items have particular relationships between each other, as shown by the dashed lines between certain content items. Similarly, some users have particular relationships between certain other users, as shown by the dashed lines between users. The content items are preferably related to users by using metadata elements. For instance, the metadata elements t1, t2, and t3 relate and/or are associated to a specific pairing of one of the users and one of the content items. In another instance, the metadata elements t8 and t9 relate a different content item and user pairing. In some embodiments, the metadata elements include tags, for example. As described above, embodiments of the invention advantageously identify and/or select one or more combinations of content items, metadata elements, and/or users for the targeting of advertising toward users of the identified combination(s). The relationships between content, users, and metadata are further described in Yahoo Research paper: “HT06, Tagging Paper, Taxonomy, Flickr, Academic Article, To Read,” by Cameron Marlow, Mor Naaman, Danah Boyd, and Marc Davis, which is incorporated herein by reference.

Advantages

Implementations of the invention are used in conjunction with conventional advertising systems such as the Yahoo Publisher Network. These conventional advertising systems are used by content publishers to monetize existing online content by targeting and/or serving advertising based on the existing content. The system of some embodiments serves advertisements at a variety of levels of granularity. The level of granular targeting is advantageously based on the granularity of information regarding the content being presented, the user of the content, and/or, by the metadata associated with the content. In particular, the metadata that is associated with the content preferably includes user generated keywords. The metadata for the user generated keywords further serve as a form of query expansion beyond the actual user generated metadata or keywords.

Some implementations leverage collaborative filtering that automatically occurs with relationships between items, users, metadata elements, and user generated metadata elements. Some systems continuously build, improve, and/or edit the generated vocabulary so that slang, colloquialisms, idioms, euphemisms, metaphors, and other cultural context, are automatically updated. Advantageously, advertisers are provided with current vocabulary, usage, and trends for targeted advertisements. One implementation has built-in analytical tools. For instance, one such tool is for ranking the relevancy and/or interestingness of advertisements based on user actions, while another tool includes feedback for adjusting the constructed vocabulary of metadata elements.

Bidding

In one implementation of the embodiments described above, an advertiser is selected for a metadata element or set of metadata elements based on a bidding process. For instance, advertisers bid on keywords or sets of keywords and an advertiser is selected from the bidding. Advantageously, users of particular embodiments place bids on keywords that are paired with particular sets of items, subject matter types, genres, and/or categories. These users may also place bids on keywords paired with a specific item or with specific subject matter. In another option, users place bids with keywords paired with item communities.

For instance, a user Jane wants to advertise her extreme skateboard event to a community of avid skateboarders. Advantageously, Jane logs onto a system for providing bidding services in relation to metadata elements, and browses to a category such as, for example, Sports> Extreme Sports> Skateboard category. Jane places a bid on the terms or metadata elements ‘skateboard event’ and also on the terms “Gnar” and the phrase “Make Gnar” based on recommendations provided by the system.

In an alternative embodiment, the user Jane bids on a metadata element in the form of a word “Gnar” for skateboarding communities throughout a network coupled to the system. Jane's ads will be served where there is a match with a particular community such as the skateboard and/or extreme sports (user) communities, with particular subject matter such as skateboarding blogsites or blogs that have skateboarding content, photo sites with skateboard subject matter (item), and other content, users, or entities with “skateboard,” “gnar,” and/or “make gnar” metadata elements such as, for example, user generated search terms, keywords, tagging, commenting, and/or labeling.

The bidding process of some embodiments, allows bidders to log onto a system for receiving the bids. Then, the bidders may place bids on specific metadata elements such as search term, tag, and/or keyword bids. Alternatively, bidders may bid on combinations of metadata elements (such as terms), category type (for items), and/or community type (for users). In an implementation, the bidder selects an entity, element, or combination of the foregoing from recommendations for bidding provided to the bidder. The recommendations may be based on the bidder's explicit and/or implicit preferences.

Next, the system stores the information regarding the bids, the bidders, and/or the bidder preferences. The system pushes the advertising and/or content of the winning bidders when the bidding conditions are met, and further, with the detected co-occurrence of one or more combinations of relevant content, users, metadata elements, and/or other entity information.

By using implementations of the invention, advertisers bid on vernacular terms and other metadata elements that pertain to specific communities and/or subject matter. Advertisers further may pair bids for tags, terms, and/or other metadata elements with specific subject matter. The pairing includes finely grained pairings including pairing a bid with subject matter that relates to a specific community, at a specific time and/or date, at a specific location, and/or any combination of pairings of the foregoing or other criteria. Advertisers further pair bids with user profiles. Similarly, pairing the bids for metadata elements with user profiles is selectively at various levels of granularity. For instance, advertisers may select pairing a bid with an implicit or an explicit community or with a sub-community within a larger community. The bidding for a metadata element and user pairing includes pairing with consumer or producer groups, at a specific geographical location, and/or at a specific time, date, and/or time of year or season. Further, advertisers receive recommendations on most relevant metadata elements on which to bid based on analytical information gathered by the system regarding specific metadata elements such as, for example, on specific keywords.

While the invention has been described with reference to numerous specific details, one of ordinary skill in the art will recognize that the invention can be embodied in other specific forms without departing from the spirit of the invention. For instance, the examples given above often relate to online media. However, targeting across a multiple of media types is applicable as well. Thus, one of ordinary skill in the art would understand that the invention is not to be limited by the foregoing illustrative details, but rather is to be defined by the appended claims.

What is claimed is:

1. A method for targeting advertisements, the method comprising:
selecting a first content item having an associated set of metadata for providing information regarding the first content item;
identifying a first user having a relationship to the first content item, the first user comprising a set of profile information;
determining a first metadata element used by the first user in relation to the first content item, the first metadata element generated by one or more users of the first content item, the one or more users comprising the first user or a second user; and
selecting a first advertisement for presentation to the first user, the selecting by using data associated with one or more of the first content item, the first user, and the first metadata element.

2. The method of claim 1, wherein the first user comprises one of a producer and a consumer of the first content item, the method further comprising associating the first metadata element to at least one of the first content item, the first user, and a second metadata element.

3. The method of claim 1, further comprising collecting a list of user generated metadata elements and the associations of each user generated metadata element, the list comprising a vocabulary of metadata elements for one or more of a particular set of users, and a particular set of content items.

4. The method of claim 3, further comprising crawling a set of content resources to collect the list of user generated metadata elements.

5. The method of claim 1, further comprising presenting the selected first advertisement in conjunction with one of the first content item and the first metadata element.

6. The method of claim 1, wherein the profile information comprises one or more of demographic data, geographic data, behavioral data, interests, affiliations, groups data, and preferences, for the first user.

7. The method of claim 1, wherein the first content item comprises one of an image, a video, an audio clip, text, a link, a web page, a blog, and an online posting.

8. The method of claim 1, wherein the first metadata element comprises a user generated metadata element comprising one of a tag, a tag cloud, a label, a comment, a rating, a keyword, a content categorization, a genre categorization, and a description, that is entered by one or more of a content producer and a content consumer.

9. The method of claim 1, further comprising identifying a second user having a relationship to the first metadata element, the first and second users comprising a user community having a vocabulary comprising a set of metadata elements that are used in conjunction with the first content item.

10. A computer readable medium storing a program for targeting advertising to specific users, the program comprising sets of instructions for:
selecting a first content item having an associated set of metadata for providing information regarding the first content item;
identifying a first user having a relationship to the first content item, the first user comprising a set of profile information;
determining a first metadata element used by the first user in relation to the first content item, the first metadata element generated by one or more users of the first content item, the one or more users comprising the first user or a second user; and
selecting a first advertisement for presentation to the first user, the selecting by using data associated with one or more of the first content item, the first user, and the first metadata element.

11. The computer readable medium of claim 10, wherein the first user comprises one of a producer and a consumer of the first content item, the computer readable medium further comprising instructions for associating the first metadata element to at least one of the first content item, the first user, and a second metadata element.

12. The computer readable medium of claim 10, further comprising instructions for collecting a list of user generated metadata elements and the associations of each user generated metadata element, the list comprising a vocabulary of metadata elements for one or more of a particular set of users, and a particular set of content items.

13. The computer readable medium of claim 12, further comprising instructions for crawling a set of content resources to collect the list of user generated metadata elements.

14. The computer readable medium of claim 10, further comprising instructions for presenting the selected first advertisement in conjunction with one of the first content item and the first metadata element.

15. The computer readable medium of claim 10, wherein the profile information comprises one or more of demographic data, geographic data, behavioral data, interests, affiliations, groups data, and preferences, for the first user.

16. The computer readable medium of claim 10, wherein the first content item comprises one of an image, a video, an audio clip, text, a link, a web page, a blog, and an online posting.

17. The computer readable medium of claim 10, wherein the first metadata element comprises a user generated keyword comprising one of a tag, a tag cloud, a label, a comment, a rating, a keyword, a content categorization, a genre categorization, and a description, that is entered by one or more of a content producer and a content consumer.

18. The computer readable medium of claim 10, further comprising instructions for identifying a second user having a relationship to the first metadata element, the first and second users comprising a user community having a vocabulary comprising a set of metadata elements that are used in conjunction with the first content item.

19. A system for targeting advertisements, the system comprising:
a first content item having an associated set of metadata for providing information regarding the first content item;
a first user having a relationship to the first content item, the first user comprising a set of profile information;
a first metadata element used by the first user in relation to the first content item, the first metadata element generated by one or more users of the first content item, the one or more users comprising the first user or a second user; and
a first advertisement for presentation to the first user;
the system configured for selecting the first content item, identifying the first user, determining the first metadata element, and selecting the first advertisement by using data associated with one or more of the first content item, the first user, and the first metadata element.

20. The system of claim 19, wherein the first user comprises one of a producer and a consumer of the first content item, the system further comprising a module for associating the first metadata element to at least one of the first content item, the first user, and a second metadata element.

21. The system of claim 19, further comprising a storage device for collecting a list of user generated keywords and the associations of each user generated keyword, the list comprising a vocabulary of keywords for a particular set of users, or for a particular set of content items.

22. The system of claim 21, further comprising a module for crawling a set of content resources to collect the list of user generated keywords.

23. The system of claim 19, further comprising an inventory location for presenting the selected first advertisement in conjunction with one of the first content item and the first keyword.

24. The system of claim 19, wherein the profile information comprises one or more of demographic data, geographic data, behavioral data, interests, affiliations, groups data, and preferences, for the first user.

25. The system of claim 19, wherein the first content item comprises one of an image, a video, an audio clip, text, a link, a web page, a blog, and an online posting, wherein the first metadata element comprises a user generated metadata element comprising one of a tag, a tag cloud, a label, a comment, a rating, a keyword, a content categorization, a genre categorization, and a description, that is entered by one or more of a content producer and a content consumer.
